(19) United States
(12) Patent Application Publication
(10) Pub. No.: US 2017/0080607 A1
(43) Pub. Date: Mar. 23, 2017

(54) ANGLED LIGHT SOURCE WITH UNIFORM BROAD AREA ILLUMINATION

(71) Applicants: Richard Sahara, Edina, MN (US); Pat Corder, St. Louis Park, MN (US); DeWayne Abbas, Shakopee, MN (US)

(72) Inventors: Richard Sahara, Edina, MN (US); Pat Corder, St. Louis Park, MN (US); DeWayne Abbas, Shakopee, MN (US)

(21) Appl. No.: 14/859,060

(22) Filed: Sep. 18, 2015

(51) Int. Cl. B29C 35/08

(52) U.S. Cl. CPC B29C 35/0805; B29C 2035/0827

(57) ABSTRACT

A lighting system for illuminating a target area, including a substantially planar mounting surfaced disposed adjacent and substantially parallel to the plane of the target area, and a first plurality of collimated light sources mounted to the mounting surface and disposed to emit in a first orientation at a first predetermined angle from the mounting surface; wherein the plurality of light sources are arranged for overlapping illumination of a region of the target area, and the region is illuminated with substantially uniform intensity at a substantially common angle of incidence.

### BACKGROUND

The specification relates illumination of a surface and in particular angled uniform illumination of a broad area.

U.S. Pat. Nos. 7,382,959 and 8,663,539, along with related others and incorporated by reference, describe processes and systems for curing resin resulting in an interlocking angled structure with beneficial structural properties. Processes such as these and other processes including photolithography, holographic processing, electronic display manufacturing, curing directionally sensitive inks, selective illumination of three dimensional items, image projection, directionally dependent viewing of images, selective heating of three dimensional objects, processing of materials that have electrically, magnetic, optically or other physical anisotropic characteristics, as well as other processes, may benefit from angled illumination that is substantially uniform over a broad area.

### BRIEF DESCRIPTION

In some embodiments, a light source may be provided that provides collimated illumination at one or more angles to a substantially flat target area, where the illumination is relatively uniform over a broad area.

In some embodiments a lighting system for illuminating a target area may be provided, including a substantially planar mounting surface disposed adjacent and substantially parallel to the plane of the target area, and a first plurality of collimated light sources mounted to the mounting surface and disposed to emit in a first orientation at a first predetermined angle from the mounting surface; wherein the plurality of light sources are arranged for overlapping illumination of a region of the target area, and the region is illuminated with substantially uniform intensity at a substantially common angle of incidence.

In some embodiments common angle and intensity may be scaled to a larger region of the target area by making the mounting surface larger and mounting more light sources.

In some embodiments at least one additional plurality of light sources may be disposed to emit in at least one second orientation to the first plurality and at one of the first or a second predetermined angle from the mounting surface.

In some embodiments at least one of the pluralities of sources may mounted on a pyramidal structure extending from the plane of the mounting surface in the direction of the target area.

In some embodiments the collimated illumination sources may be UltraViolet (UV) light sources.

In some embodiments at least one of the pluralities of sources may be mounted on an angled support structure extending from the plane of the mounting surface.

In some embodiments at least one of the pluralities of sources may be directed to target area by an angled mirror.

In some embodiments at least one of the pluralities of sources may be directed to target area by a prism.

In some embodiments at least a portion of the first plurality of sources may overlap the second plurality of sources.

In some embodiments emission wavelength of the collimated sources may be chosen to be a wavelength suitable for curing a given resin material.

In some embodiments, at least one of two pluralities of sources may be oriented with a second plurality directed 180 degrees away from the first, three pluralities are oriented at 120 degrees to each other, four pluralities are oriented at 90 degrees to each other, five pluralities are oriented at 72 degrees to each other, or six pluralities are oriented at 60 degrees to each other.

In some embodiments, multiple pluralities are oriented asymmetrically on the mounting surface.

In some embodiments, the angle from the mounting surface can be adjusted dynamically.

In some embodiments, at least a portion of the first plurality of sources overlap the second plurality of sources and the number of beams overlapping in the target area from a single direction is between zero and 20.

In some embodiments, the distance between the target area and mounting surface (the working distance) ranges between 6″ and 60″.

In some embodiments, the spacing between the light sources is greater than 0.25″.

In some embodiments, the spacing between the light sources is greater than 1″.

In some embodiments, the optical output of individual illumination sources are adjustable to improve the uniformity of the optical pattern or to introduce a pattern into the target.

In some embodiments, one or more individual light sources may be affixed to an individual angled support structure or individual pyramidal structure.

### BRIEF DESCRIPTION OF THE DRAWINGS

FIGS. 1 and 2 depict light sources with less desirable illumination uniformity;

FIG. 3a, FIG. 3b, FIG. 3c and FIG. 3d depict techniques for collimating an LED light source;

FIG. 4 is an implementation of the uniform light source according to an illustrative embodiment of the invention;

FIG. 5 is an implementation of the uniform light source according to another illustrative embodiment of the invention;

FIG. 6 is an implementation of the uniform light source according to another illustrative embodiment of the invention;

FIG. 7 is an implementation of the uniform light source according to another illustrative embodiment of the invention;

FIG. 8a, FIG. 8b, FIG. 8c, FIG. 8d, and FIG. 8e are top views of a portion of the lighting system showing several exemplary light source clocking angle orientations according to illustrative embodiments of the invention;

FIG. 9 shows the concept of beam overlap from a single direction of a light source array according to an illustrative embodiment of the invention;

FIG. 10 illustrates beam steering according to an illustrative embodiment of the invention;

FIG. 11 illustrates mounting of multiple individual light sources on a support structure according to an illustrative embodiment of the invention.

### DETAILED DESCRIPTION OF ILLUSTRATIVE EMBODIMENTS

One or more embodiments described herein may provide angled collimated light illumination over broad area with substantially uniform intensity.

One or more embodiments described herein may provide for ease of scaling the illumination area up while maintaining uniformity

One or more embodiments may use UV curing resin with collimated light entering the resin at selected angles, wherein a broad area of resin is exposed to angled light of uniform intensity.

As described in the incorporated references, angled collimated UV light may be arranged to illuminate a target area of resin, which is masked off, usually with a series of apertures spaced and sized as desired. Thus light entering an aperture causes cured regions of resin to propagate through the resin mass at the angles of the collimated light. These angled struts cure while the rest of the resin does not, thus allowing for the uncured resin to be drawn off leaving a structured material consisting of interlocking angled struts. The properties of the material can be architected by changing the size and spacing of the mask apertures and the angles and number of different angles of the collimated curing source.

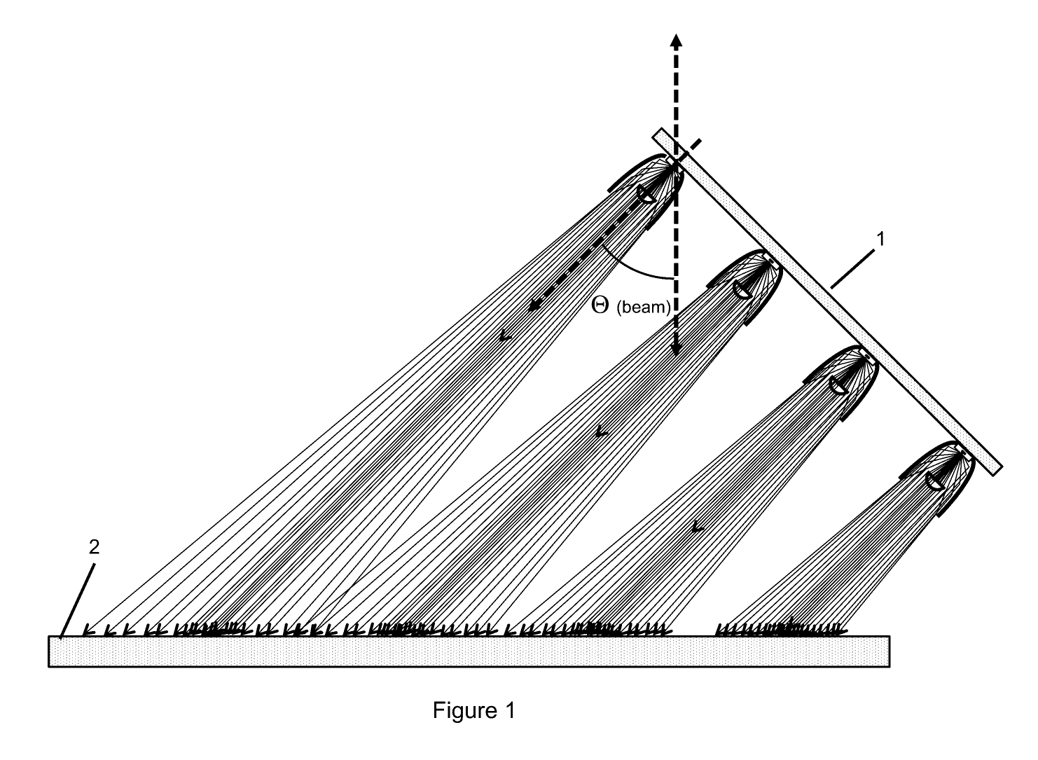

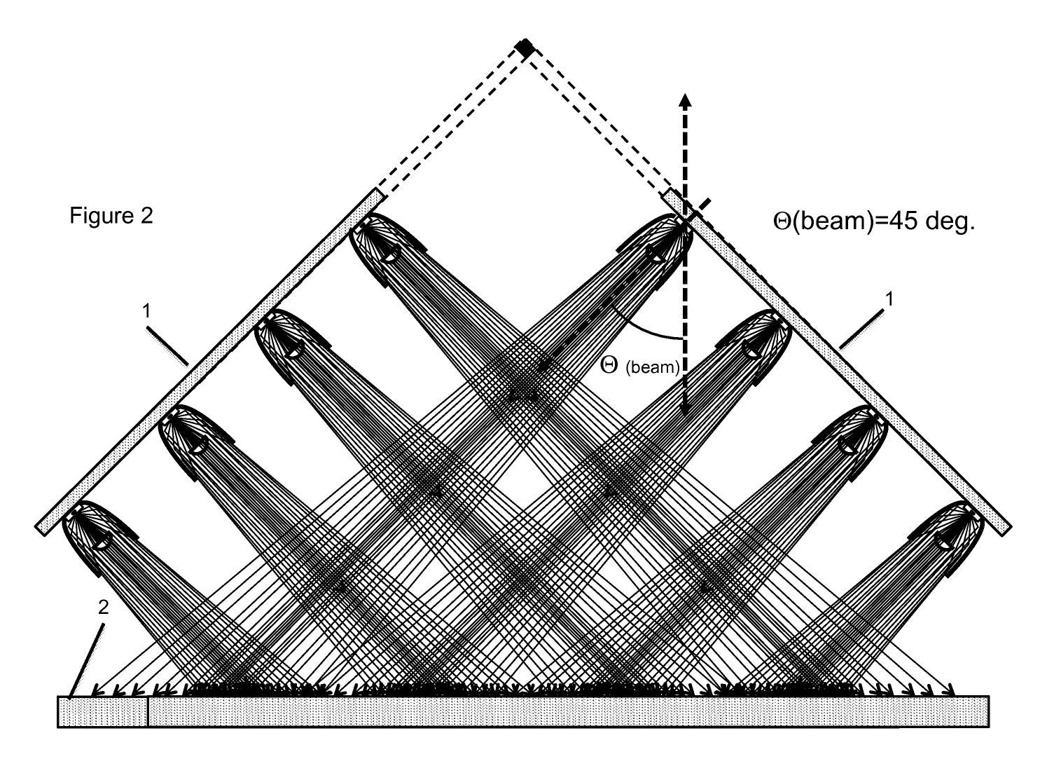

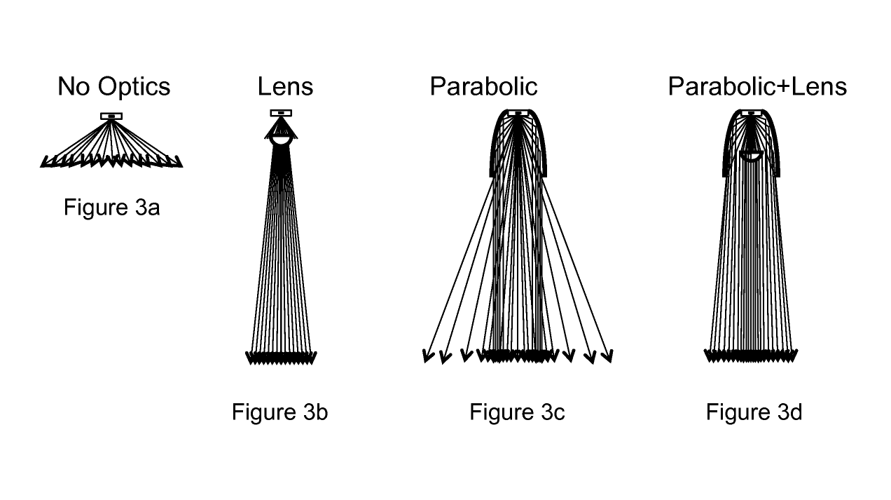

Banks of UV sources for direct straight down illumination for curing are used. However for angled illumination, such banks are less desirable. Referring to FIGS. 1 and 2 Banks of UV sources, which may in some embodiments be UV LED's may be mounted at one (FIG. 1) or more (FIG. 2) angles Θ. Note, the propagation distance from the light source 1 to the target 2 varies from illumination source to source. For long propagating distances, the beam expands to cover a large area with a low irradiance and considerable overlap from multiple light sources. For short working distances, the beam is small when it strikes the target, so the irradiance is high, but there may be gaps between the spot from adjacent light sources. Also, it is difficult to create large process areas. Extended plates (dashed line) from two banks of sources will collide with each other (black area). FIG. 3a, FIG. 3b, FIG. 3c and FIG. 3d illustrate a variety of techniques for producing collimated light from a source such as a UV LED.

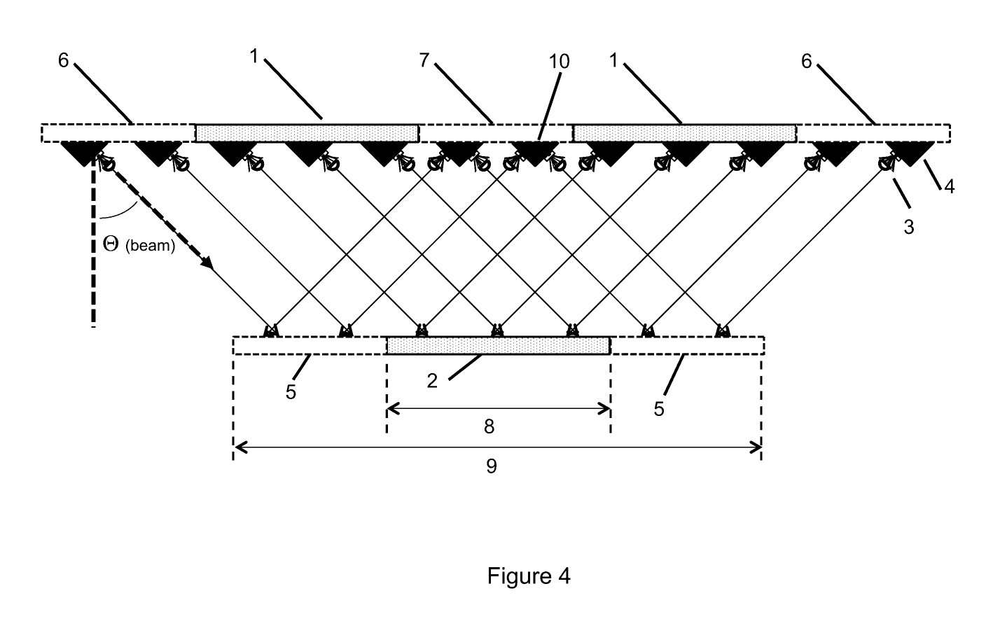

FIG. 4 depicts an exemplary embodiment of a light system 1 which solves many of the problems associated with angled banks of sources. One or more individual light sources, 3, are mounted on angled support structures, 4, pyramids in this example. The angled supports are mounted to a substantially flat mounting surface that is configured to be substantially parallel to the target area.

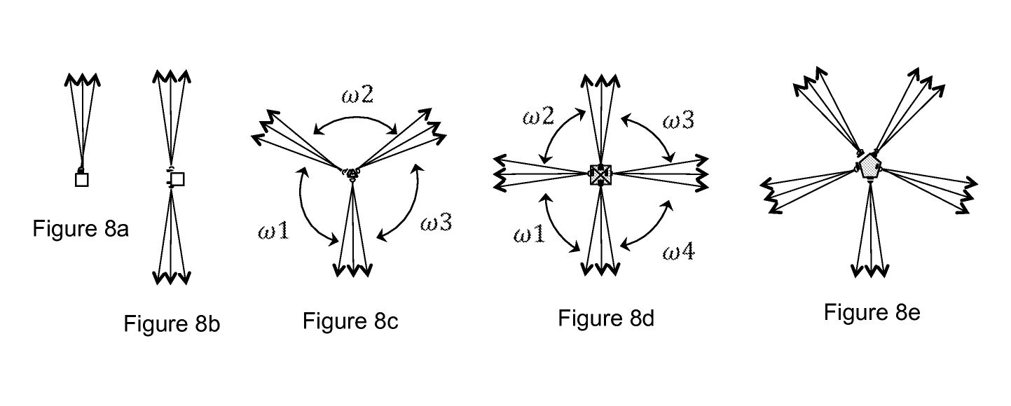

FIG. 4 shows two pluralities of light sources, oriented 180 degrees apart. Referring to FIGS. 8a-e, pluralities of light sources may be oriented at clocking angles to each other, depicted as angles w in FIGS. 8a-e. For instance the situation of FIG. 4 is depicted in the FIG. 8b, where the clocking orientation angle, ω1 is 180 degrees between two pluralities of light sources. As shown in the FIGS. 8b-e, one through many pluralities of sources oriented at various clocking angle may be employed in various embodiments. The clockings may be symmetric, ie all angles ω are for each case, such as 120 degrees for FIG. 8c, 90 degrees for FIG. 8c and so on, or all angles ω between pluralities may not all be the same. The pluralities may be mounted co-located as is shown in the center section of FIG. 4, or mounted separately and apart as shown in the outer sections of FIG. 4.

Each plurality is directed at an angle to the target area, 2. The directed angle, referred to as the beam angle Θ in FIG. 4, may differ between different pluralities. Note, the propagation distance of the beams are all the same for a given plurality or predetermined beam angle. In this configuration, therefore, the spot size of the beams and irradiance will be uniform from illumination source to source. Each support 4 may contain one or more light sources 3. For some architected material designs, the struts may be at the same angle relative to normal to the resin surface, but arranged at different orientations. Thus in FIG. 4 one plurality is shown on one face, and the other plurality is mounted to the opposite face, 180 degrees apart, both at an angle Θ, which may be the same to normal but oriented 180 degrees apart such that the emitted light is directed 180 degrees apart when viewed from the target area. As shown in FIG. 8, this may be expanded to three, four or more pluralities

As shown in FIG. 4, the initial target area 8 can be expanded to larger target area 9 by extending the mounting surface 1 into surfaces 6 and 7 and mounting more light sources. Thus this arrangement scales directly. In this embodiment, extended area 7 contains support structures with multiple angled pluralities, 10, while extended areas 6 contain support structures with a single angled plurality. As the target area scales further, the extended area containing multiple angled pluralities 10 will continue to expand. Note that the light beams shown in FIG. 4 are represented as a single light ray to simply the figure.

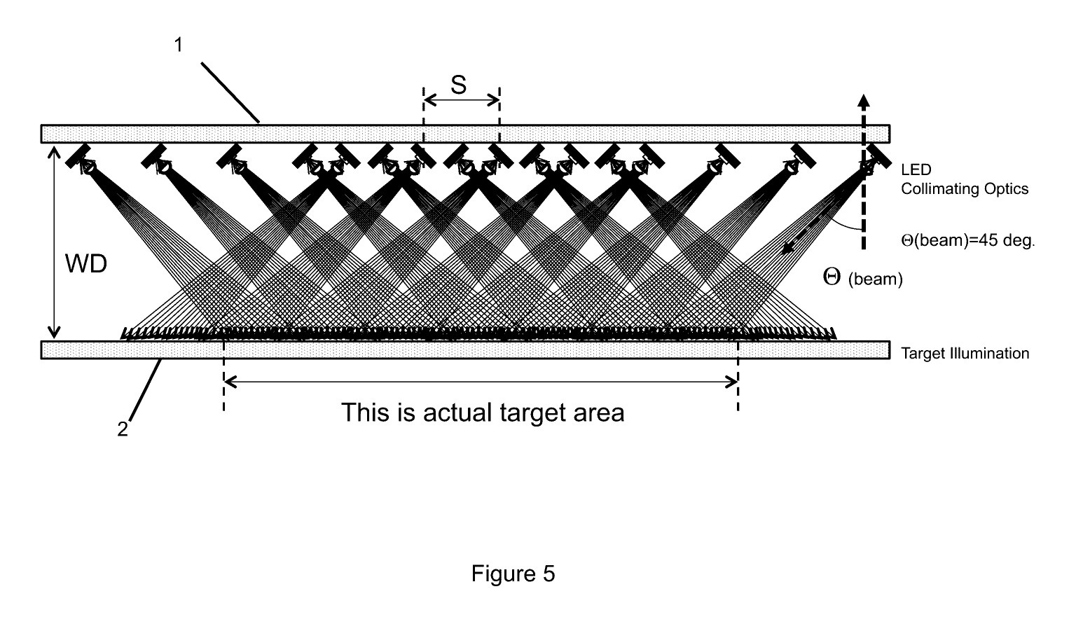

FIG. 5 shows an alternative embodiment, where instead of pyramids, angled single support structures are used. This arrangement allows for more flexibility in the placement and angles of the pluralities of light sources, for both asymmetric or symmetric angled illumination as desired. This configuration also allows the beam angles (theta) to be adjusted dynamically if required for a particular process application. FIG. 5 also shows the spacing between angled supports within a plurality as S and the working distance between the mounting plate and target plane as WD.

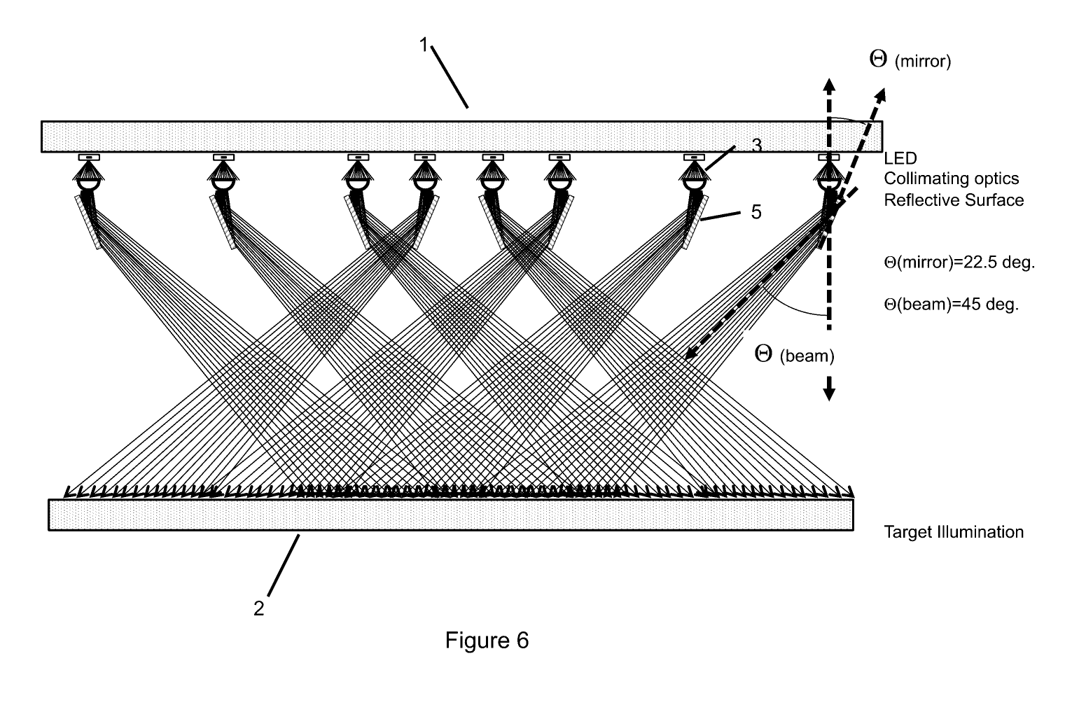

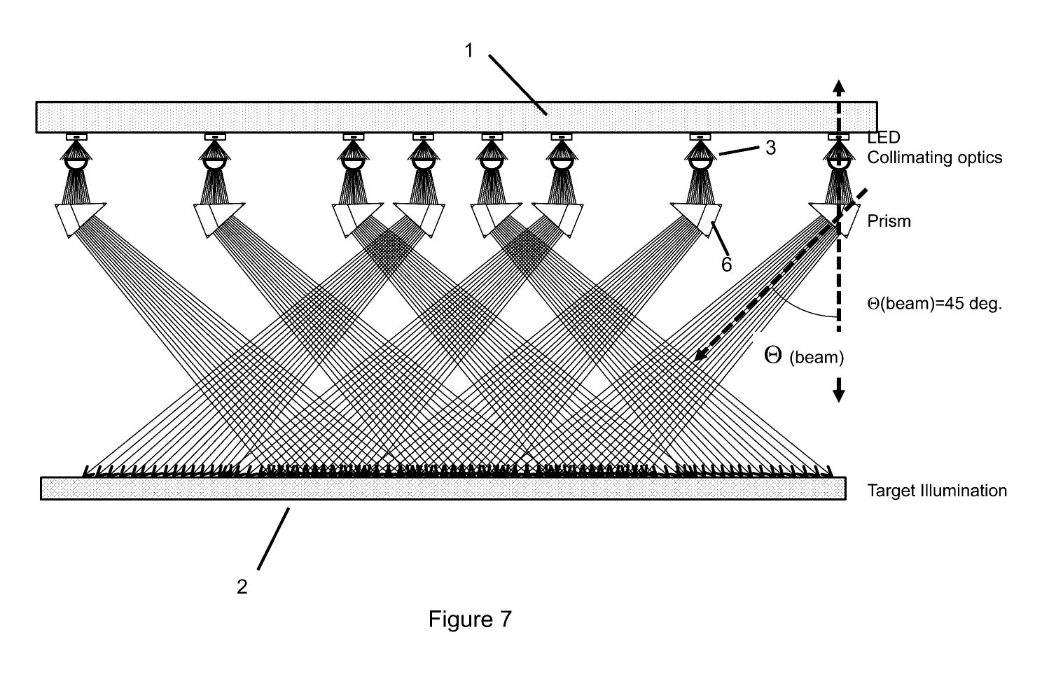

FIG. 6 depicts an alternative where the beam angle is not determined by the angle of a support structure but by directing the sources 3 to mirrors 5 which set the beam angle. FIG. 7 achieves the desired illumination angles by directing sources 3 to prisms 6 which determine the beam angle.

FIG. 8a, FIG. 8b, FIG. 8c, FIG. 8d, and FIG. 8e depict a top view of individual light sources from different pluralities. These may be arranged in a group, as, for example, would occur when the illumination sources are mounted to the same support structure or co-located support structures. This arrangement demonstrates the various light source symmetries used in different embodiments. The mounting of pluralities can be achieved with multiple facets on a pyramid, multiple angled plates, or by directing the light using prisms or mirrors.

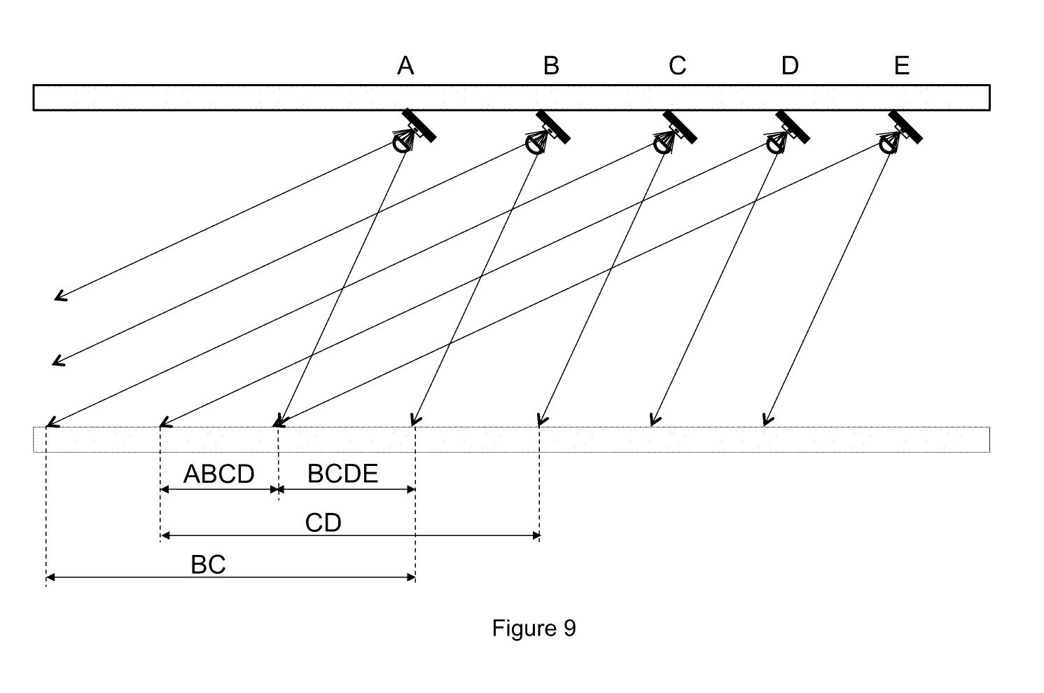

FIG. 9 shows the intersection of multiple beams emanating from different light sources affixed to different support structures on the light source. As the intensities of individual light sources may vary, overlapping the beams mitigates the intensity variation and creates a more uniform irradiance on the target surface. As the amount of beam overlap increases, however, the size of the mounting surface must increase so that the illumination in a given target area remains uniform. In various embodiments, the ideal amount of beam overlap from a single plurality ranges from zero (no overlap) to twenty. The total beam overlap in the actual target area will be the overlap from a single plurality multiplied by the total number of pluralities used in the light source.

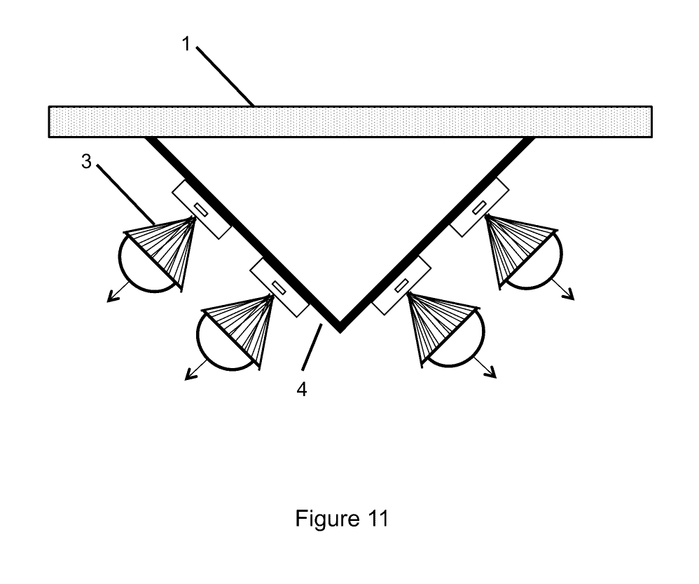

A variety of individual light sources may be employed for different embodiments. Multiple light sources of different types may be employed, for example to illuminate at more than one wavelength. Individual light sources may in some embodiments be a single LED die, or an array of multiple LED die. In addition, multiple individual light sources may be attached to a single support structure as shown in FIG. 11. The optical output of individual LEDs within a light system may be adjusted to change the optical pattern from a light system. The optical output of individual LED's within a light system may be adjusted to improve the uniformity of the optical pattern, or intentionally introduce pattern into the target pattern. The output of light sources for the various directions may be changed dynamically to sequentially control the process of the angularly dependent target. Different wavelength light sources, including different wavelength LEDs or broad spectrum sources spanning a range in wavelengths may be employed in some embodiments. In some embodiments, UV wavelengths of 385+/−15 have optimal effect. In some embodiments, wavelengths of 365+/−15 have optimal effect. Ranges between 390-430 have found use processing broadly available adhesives, inks and 3 dimensional printed materials. Ranges above 760 nm are useful for IR heating applications. Optimal wavelength choice depends on the formulation of the substance to be cured, and can be tailored for as needed for different chemistries

Although the embodiments shown in the figures show the light systems arranged above an illuminated area, clearly any orientation of the target area is possible, including below a light system beside a light system or above a light system and at any angle relative to the ground.

The spacing between individual light sources (See dimension S in FIG. 5) may depend on various factors, including the working distance, required beam overlap, and the size required to support clusters of a specific number of pluralities. For support structures to which individual LEDs are affixed, spacing of 0.25″ and greater may be viable. If multiple LEDs are used for each support structure for a given illumination, then spacing (S) can be 1″, 2″, or greater depending on the number of LEDs required. Spacing in certain embodiments may be less than 0.6″.

Some current systems have working distances between 3 to 5 feet. The new embodiments can create sufficient uniformity at shorter working distances, enabling working distances of less than 6″ to become practical. Working distances between 6″ and 24″ may be desirable. Working distances greater than 24″ are also viable and may sometimes be required due to part geometry. Distances between 6″and 60″ may be used for certain illumination applications.

Overlapping of the beams may enable a more uniform irradiance on the target and mitigates the influence of light source output variability. FIG. 9 shows the geometry of five overlapping light sources, labeled A, B, C, D, and E. Given the working distance, spacing and beam spread, the steady state overlap of the embodiment in FIG. 9 is 4 in one direction. This is shown as area ABCD and BCDE. As additional individual light sources are added and the light system is expanded, this steady state overlap area will expand but the number of overlapping beams will remain at 4. The number of overlapping beams may range from none to as many as 20 or more for certain embodiments.

The optical collimating elements, such as those shown in FIG. 3 may be chosen to be dynamically adjustable to accommodate various target patterns, target process incident angle adjustments, overlap and beam uniformity.

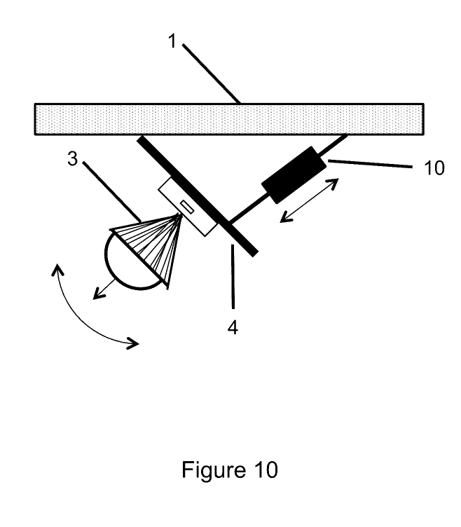

Illumination beam angle theta (see FIG. 5) can be configured to range from 0 to 80 degrees, depending on the geometry of the light system and target area. The beam angle may be adjusted dynamically by phase array beam steering of the LED source, piezo or electro mechanical motion of the individual light sources, moveable mirrors or steering prisms. Such an arrangement is shown schematically in FIG. 10 where the angle of support 4 for individual light source 3 is adjusted by adjustment element 10. The beam steering adjustment element 10 may be discrete optical components or mechanical positioning devices associated with individual light sources. The beam steering function may be executed by an array of optical components working on a large collimated beam.

Depending on mounting configuration, the beam symmetry may be adjusted by changing the orientation angle (ω in FIG. 8a, FIG. 8b, FIG. 8c, FIG. 8d, and FIG. 8e) between the different light directions. For instance, in FIG. 8d, the light sources may be adjusted such that the angle ω1 increases and the angle ω4 decreases.

A detailed embodiment suitable for an architected material curing application is described as follows.

### DETAILED EMBODIMENT

WD is the distance from an LED array light system to the processing material. A working distance of 18 inches from the plane of the LED arrays to the target area plane of illumination is desirable for this embodiment. The plane of illumination and the plane of LEDs may be substantially parallel in this embodiment, with the target area including a vessel holding resin to be cured and therefore the target area is substantially flat with the light source disposed above the target area.

The beam angle is the angle of the beam relative to the line that would be perpendicular to the planes of the LED array and plane of illumination. The beam angle is at 45 degrees for this embodiment.

The propagation distance is the distance the center of the optical beam must propagate from the plane of the LED array to the illumination plane. If the beam angle is zero degrees, the propagation distance is equal to the distance from the LED array plane to the illumination plane. For a beam angle of 45 degrees and a working distance of 18 inches, the propagation distance will be 25.4 inches.

Spacing (S)=is the distance between individual LED light sources within the plane of the LED array. The distance is 2 inches in this embodiment. This places the LED light sources on a grid of 2 inches by 2 inches within the plane of the LED array. There will be one set of LED arrays for each direction of light source symmetry. Depending on the size of the target area, the LED arrays may overlap for the different directions of light source symmetry.

The light from individual light sources will spread as the beam propagates. A narrow angle of beam spreading facilitates good processing of many materials. The beam spreading angle is 7 degrees, half width half maximum. The diameter of the light spot will be about 0.4 inches at the output of the individual light source. At a propagating distance of 25.4 inches, the diameter of the optical spot will be 6.6 inches. With the optical beam propagating at a 45 degree angle from the LED array plane and illumination plane, the optical pattern on the illumination plane will be elliptical. The 6.6 inch diameter corresponds to the narrow diameter of the ellipse.

The LED spacing in the array is 2 inches by 2 inches in this embodiment. The light source density is one light source per 4 square inches. At the propagation distance, the beam diameter is 6.6 inches and has an illumination area of 34.7 square inches. In this embodiment, each point in the illumination plane will receive light from 8 light sources from one direction in the LED plane.

The target illumination area is 4 ft. long and 1 ft. wide in this embodiment. The size of each light source array must be larger than the illumination area because of the expansion of the light beams over the propagation distance. The light source array plane must be larger than the target area, by the amount of the beam expansion over the propagation distance. This is to ensure that the edges of the target area receive light from the light sources pointed directly at it, as well as the neighboring light sources that have expanded over it. As discussed in the beam overlap description, each point in the target area should be illuminated by 8 light sources, even at the perimeter of the target area.

The LED array should be one beam diameter wider than the target area and one beam diameter longer than the target area at a minimum. The width of the LED array should be one beam radius wider on each side, and one radius of beam longer at each end of the LED array. These requirements dictate a LED array width of 18.6 inches and a LED array length of 54.6 inches for this embodiment. The area of the LED array is 1019 square inches.

To cover an area of 1019 square inches with light sources spaced 2×2 inches apart will require 255 light sources. The system will need 255 light sources from each direction, so for a system with three fold symmetry, ie three sources mounted 120 degrees apart, a total of 764 light sources will be needed.

With three fold symmetry, the three beams are a 120 degrees relative to each other, mounted on three-sided pyramidal supports. Thus, the orientation angle ω, as shown in FIG. 8, is 120 degrees. With a working distance of 18 inches and a 45 degree off axis beam, the lateral displacement of the beams will be 18 inches. The light source array for each direction will cover an area of 18.6×54.6 square inches. In some areas, the light source array from multiple directions will overlap. In these areas, the light source array will direct beams from two or three directions simultaneously.

The embodiments described herein are exemplary. Modifications, rearrangements, substitute devices, processes, etc. may be made to these embodiments and still be encompassed within the teachings set forth herein.

1. A lighting system for illuminating a target area, comprising;
a. a substantially planar mounting surfaced disposed adjacent and substantially parallel to the plane of the target area, and;
b. a first plurality of collimated light sources mounted to the mounting surface and disposed to emit in a first orientation at a first predetermined angle from the mounting surface; wherein the plurality of light sources are arranged for overlapping illumination of a region of the target area, and the region is illuminated with substantially uniform intensity at a substantially common angle of incidence.

2. The lighting system of claim 1, wherein the common angle and intensity may be scaled to a larger region of the target area by making the mounting surface larger with mounting more light sources.

3. The lighting system of claim 1 further comprising at least one additional plurality of light sources disposed to emit in at least one second orientation to the first plurality and at one of the first or a second predetermined angle from the mounting surface.

4. The lighting system of claim 3 wherein at least one of the pluralities of sources is mounted on a pyramidal structure extending from the plane of the mounting surface in the direction of the target area.

5. The lighting system of claim 4 wherein at least a portion of the first plurality of sources overlap the second plurality of sources.

6. The lighting system of claim 1 wherein the collimated light sources are UltraViolet (UV) light sources.

7. The lighting system of claim 3 wherein at least one of the pluralities of sources is mounted on an angled support structure extending from the plane of the mounting surface.

8. The lighting system of claim 7 wherein at least a portion of the first plurality of sources overlap the second plurality of sources.

9. The lighting system of claim 3 wherein at least one of the pluralities of sources is directed to target area by an angled mirror.

10. The lighting system of claim 9 wherein at least a portion of the first plurality of sources overlap the second plurality of sources.

11. The lighting system of claim 3 wherein at least one of the pluralities of sources is directed to target area by a prism.

12. The lighting system of claim 11 wherein at least a portion of the first plurality of sources overlap the second plurality of sources.

13. The lighting system of claim 1 wherein emission wavelength of the collimated sources is chosen to be a wavelength suitable for curing of a given resin material.

14. The lighting system of claim 3, wherein at least one;
a. two pluralities of sources are arranged with a second plurality oriented 180 degrees away from the first;
b. three pluralities are oriented at 120 degrees to each, or;
c. four pluralities are oriented at 90 degrees to each other.
d. Five pluralities are oriented at 72 degrees to each other.
e. Six pluralities are oriented at 60 degrees to each other.

15. The lighting system of claim 3 wherein multiple pluralities are oriented asymmetrically on the mounting surface.

16. The lighting system of claim 1, where the angle from the mounting surface can be adjusted dynamically.

17. The lighting system of claim 3 wherein at least a portion of the first plurality of sources overlap the second plurality of sources and the number of beams overlapping in the target area from a single direction is between zero and 20.

18. The lighting system of claim 1 wherein the distance between the target area and mounting surface (the working distance) ranges between 6″ and 60″.

19. The lighting system of claim 1 wherein the spacing between the light sources is greater than 0.25″.

20. The lighting system of claim 1 wherein the spacing between the light sources is greater than 1″.

21. The lighting system of claim 1 wherein the optical output of individual illumination sources are adjustable to improve the uniformity of the optical pattern or to introduce a pattern into the target.

22. The lighting system of claim 4 wherein one or more individual light sources are affixed to an individual pyramidal structure.

23. The lighting system of claim 7 wherein one or more individual light sources are affixed to an individual angled support structure.
